(19) United States
(12) Patent Application Publication
(10) Pub. No.: US 2014/0013230 A1
(43) Pub. Date: Jan. 9, 2014

(54) INTERACTIVE VIDEO RESPONSE PLATFORM

(71) Applicant: Hanginout, Inc., Carlsbad, CA (US)

(72) Inventor: Justin Barnett Malone, Carlsbad, CA (US)

(21) Appl. No.: 13/937,164

(22) Filed: Jul. 8, 2013

Related U.S. Application Data
(60) Provisional application No. 61/668,958, filed on Jul. 6, 2012.

(51) Int. Cl. H04N 5/93

(52) U.S. Cl. CPC H04N 5/93
USPC 715/723

(57) ABSTRACT

An interactive video response platform creates a seamless video playback experience by receiving stimulus from an audience member, receiving a first video content from a content producer on the interactive video response platform, and displaying video content in response to the stimulus on the interactive video response platform. The seamless video playback can include a transition between video content clips, such that there is little or no discernable end to one video clip before another begins. The seamless video playback can also include multiple types of segments that can be displayed, including those that can be played while awaiting stimulus from the audience member.

### CROSS-REFERENCE TO RELATED APPLICATIONS

This application claims priority to U.S. Provisional Patent Application No. 61/668,958, filed Jul. 6, 2012, titled, “Interactive Video Response Platform,” the disclosure of which is hereby incorporated by reference in its entirety herein.

### TECHNICAL FIELD

The subject matter described herein relates to persistent, seamless video interaction.

### BACKGROUND

In today's media rich world, persons of interest such as celebrities, politicians, leaders of large organizations and other famous individuals are looking for various ways to communicate with an audience. More and more, people are looking for interaction beyond written interviews. Internet chatting sessions, web-cast town hall meetings, and status updates are a more interactive means for a person of interest to communicate. However, these can be time intensive and may not be convenient for either the person of interest or their audience in terms of timing and duration.

### SUMMARY

In one aspect, a method is presented that includes receiving a stimulus from a first user on an interactive video response platform, receiving a first video content from a second user on the interactive video response platform, displaying the first video content in response to the stimulus on the interactive video response platform, and displaying a second video content on the interactive video response platform, in which the second video content is displayed as the first video content ends, creating a seamless video playback experience.

In some variations one or more of the following can optionally be included. The method can further include displaying a third video content on the interactive video response platform before the second video content ends. The second video content can be a waiting video, displayed in response to a lack of stimulus from the first user. In some implementations, the seamless video playback experience can include a cross-fade dissolve transition between the first video content and the second video content. Further, in some implementations, the method includes displaying a welcome video clip to the first user prior to displaying the first video content. In some such implementations, the welcome video can include a prompt to provide a stimulus comprising a question. The second user can create the first video content through a web site, a proprietary application, or a video production studio. The interactive video response platform can be accessed by the second user through a web site, a proprietary application, a one or more video production studios associated with the interactive video response platform, or any suitable combination thereof.

In a related aspect, a system is presented that includes at least one programmable processor and a machine-readable medium storing instructions that, when executed by the at least one processor, causes the at least one programmable processor to perform the following operations. The operations include receiving a stimulus from a first user via an interactive video response platform; receiving a first video content from a second user on the interactive video response platform, the first video content comprising a response to the stimulus; displaying the first video content in response to the stimulus on the interactive video response platform; and displaying a second video content on the interactive video response platform, in which the second video content is displayed as the first video content ends, creating a seamless video playback experience.

In some variations of the computer program product one or more of the following can optionally be included. The machine-readable medium can further include instructions that cause the at least one programmable processor to further perform the operation of displaying a third video content on the interactive video response platform before the second video content ends in some implementations. In such implementations, the second video content can be a waiting video, displayed in response to a lack of stimulus from the first user. The seamless video playback experience can include a cross-fade dissolve transition between the first video content and the second video content. In some implementations of the system, the machine-readable medium can further include instructions that cause the at least one programmable processor to further perform the operation of further comprising displaying a welcome video clip to the first user prior to displaying the first video content. In such implementations, the welcome video can include a prompt to provide a stimulus comprising a question. The interactive video response platform can be accessed by the first user through a web site, a proprietary application, or both a web site and a proprietary application. In some implementations, second user can create the first video content through a web site, a proprietary application, or a video production studio.

Further, in a related aspect a computer program product is presented that includes machine-readable medium storing instructions that, when executed by at least one programmable processor, cause the at least one programmable processor to perform the following operations. The operations include receiving a stimulus from a first user via an interactive video response platform; receiving a first video content from a second user on the interactive video response platform, the first video content comprising a response to the stimulus; displaying the first video content in response to the stimulus on the interactive video response platform; and displaying a second video content on the interactive video response platform, in which the second video content is displayed as the first video content ends, creating a seamless video playback experience.

In some variations of the system, one or more of the following can optionally be included. The machine-readable medium can also include instructions that cause the at least one programmable processor to further perform the operation of displaying a third video content on the interactive video response platform before the second video content ends in some implementations. In such implementations, the second video content can be a waiting video, displayed in response to a lack of stimulus from the first user. The seamless video playback experience can include a cross-fade dissolve transition between the first video content and the second video content.

Implementations of the current subject matter can include, but are not limited to, systems and methods, as well as articles, that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a particular software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a schematic of a timeline of content display when awaiting stimulus by an exemplary interactive video response platform;

FIG. 2 is a schematic of a timeline of content display by an exemplary interactive video response platform when a stimulus is provided; and

FIG. 3 is a diagram showing an example of interaction between an interactive video response platform and one or more users.

When practical, similar reference numbers denote similar structures, features, or elements.

### DETAILED DESCRIPTION

The interactive video response platform methods, apparatus, and systems described herein allows a content publisher to effectively communicate with an audience in a manner that is engaging, responsive to stimulus, and is accessible without time or timing constraints.

A content publisher, such as a person of interest, can use an interactive video response platform, as described herein, to communicate with an audience that can include fans, curious persons, students, and the like. The interactive video response platform can allow the content publisher to provide novel, quality video content in response to stimulus from the audience. The content publisher can create content at any time that is convenient for him or her. The audience can view the video content at any convenient time; direct the presentation of the video content; and because the interactive video response platform provides the content in a persistent, seamless manner, the audience can simulate a conversation with the person of interest.

A person of interest, also known as a content publisher, can be a celebrity, an instructor, a subject expert, a politician, an industry leader, a company executive, a potential employee, a potential date, or any other person that an audience would like to communicate with or learn more about. Such persons can seldom be available to answer the question of every fan, student, friend, interested date, or follower in an audience as the question arises.

A person of interest can interact with the interactive video response platform to generate content through a website, a customized application, a studio associated with the interactive video response platform where content can be generated, and any other suitable means that allows novel and meaningful content (e.g. video clips) to be generated and avoids the uploading of unoriginal, potentially copyrighted, content that may belong to others. The novel content generated can be made available when a member of the audience wishes to interact with the person of interest to receive an answer to one or more questions.

The person of interest can receive questions from the interactive video response platform that are standardized, or use common questions that audience members often ask, and generate content in response to those questions to populate his or her profile. Additionally, or alternatively, the person of interest can generate content to populate his or her profile on the interactive video response platform in response to questions that he or she anticipates, such as a political candidate answering questions about his or her policy positions.

After audience members view content generated by the person of interest, the audience may have questions that the person of interest has not previously answered in any of his or her generated content. Such previously unanswered questions can be sent to the person of interest to potentially stimulate the production of one or more additional novel video content clips which are posted to the person of interest's profile. The person of interest can receive new questions through the interactive video response platform, as direct messages, such as a voice mail message, a text message, a instant message, an email message, and the like. The new question indicator can also be received by the person of interest through his or her profile upon interacting through his or her profile.

An audience can include one or more fans, students, followers, constituents, voters, employers, daters, curious persons, or any combination thereof A member of an audience, or an audience member, may or may not have a user profile for the interactive video response platform, but he or she may ask a question using the interactive video response platform and receive an answer from one or more persons of interest. The audience member can ask a question of a specific individual or a group of individuals through the interactive video response platform, and in turn, the interactive video response platform can return a video clip that contains an answer to the audience member's question, a list of video clips that may answer the audience member's question, or a video clip indicating that the audience member's question will be forwarded to the person of interest. If audience member asks a subsequent question while a video clip of novel content is in playback, the interactive video response platform may search for a suitable answer to the subsequent question and display the video answering the subsequent question, or list a of possible answers to the subsequent question, as soon as it is ready for display. In some implementations, the interactive video response platform may present the audience member with the option to display the answer to the subsequent question without interrupting the playback of the current answer. If there is a pause after the finish of a first video clip answer and the start of second video clip answer, then a waiting video can be displayed, during which the person of interest can prompt the audience member to ask another question.

The audience member can experience an interaction akin to a real-time, presently occurring conversation with another person by asking questions and receiving video clips containing answers via the interactive video response platform because of the seamless and persistent nature of the video clip playback. The interactive video response platform plays back videos such that there is no visible pause or end to the playback perceived by the audience member. At the end of a first video clip, the start of a second video clip is started such that there is a gradual transition from one clip to the other, in what is referred to as a cross-fade dissolve transition. The first video and second video clips can be a welcome clip generated by a particular person of interest, an answer clip, a “no-match” clip, a “waiting” clip, an “inappropriate request” clip, or another relevant video clip.

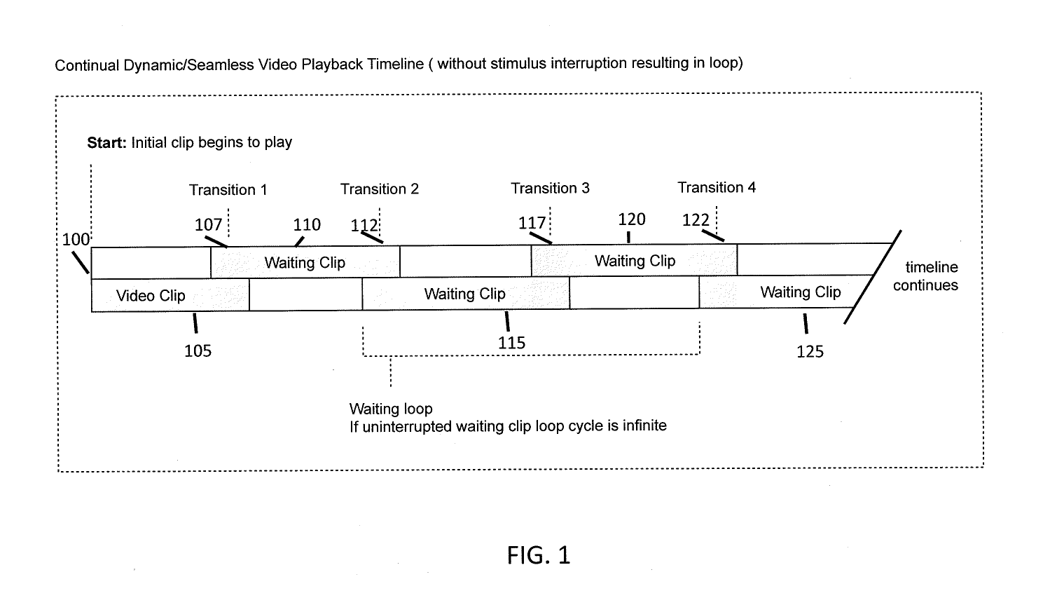

FIG. 1 is a schematic of a timeline of content displayed when awaiting stimulus by an exemplary interactive video response platform. The first clip 105 starts 100 in response to an initial stimulus, such as an audience member clicking on the profile of a person of interest. The second video clip 110 presented by the interactive video response platform can be a waiting clip when no further stimulus is received by the interactive video response platform. The first video clip 105 ends as the second clip 110 begins, and these clips overlap in a first cross-fade dissolve 107. As the second video clip 110 draws to a close, a third video clip 115 beings. If no further stimulus is received by the interactive video response platform, the third video clip 115 can be a waiting clip. The second and third video clips 110, 115 can transition in a second cross-fade dissolve 112. Further, until stimulus is received by the interactive video response platform, additional waiting clips 120, 125 can be displayed, each with a cross-fade dissolve transition 117, 122. In some implementations, if the content producer has not created more than one waiting clip, then the waiting clips 110, 115, 120, 125 can all be the same. In other implementations, each waiting clip 110, 115, 120, 125 can all be different. Waiting clips can be randomly selected, displayed in a predetermined order, or be customized to different situations. If the content producer does not have enough waiting clips for each waiting clip 110, 115, 120, 125 to be different, some of them can be the same.

A cross-fade dissolve between two video clips can be achieved in two ways; linearly or non-linearly. For example, video clip A is on a presentation layer above video clip B. Over a duration of X amount of time, the opacity of video clip A can be linearly or non-linearly adjusted from 1 to 0, where 1 has no opacity and 0 is completely transparent, and 0.5 would be 50% transparent. Video clip B will seem to gradually appear from beneath an increasingly fainter video clip A.

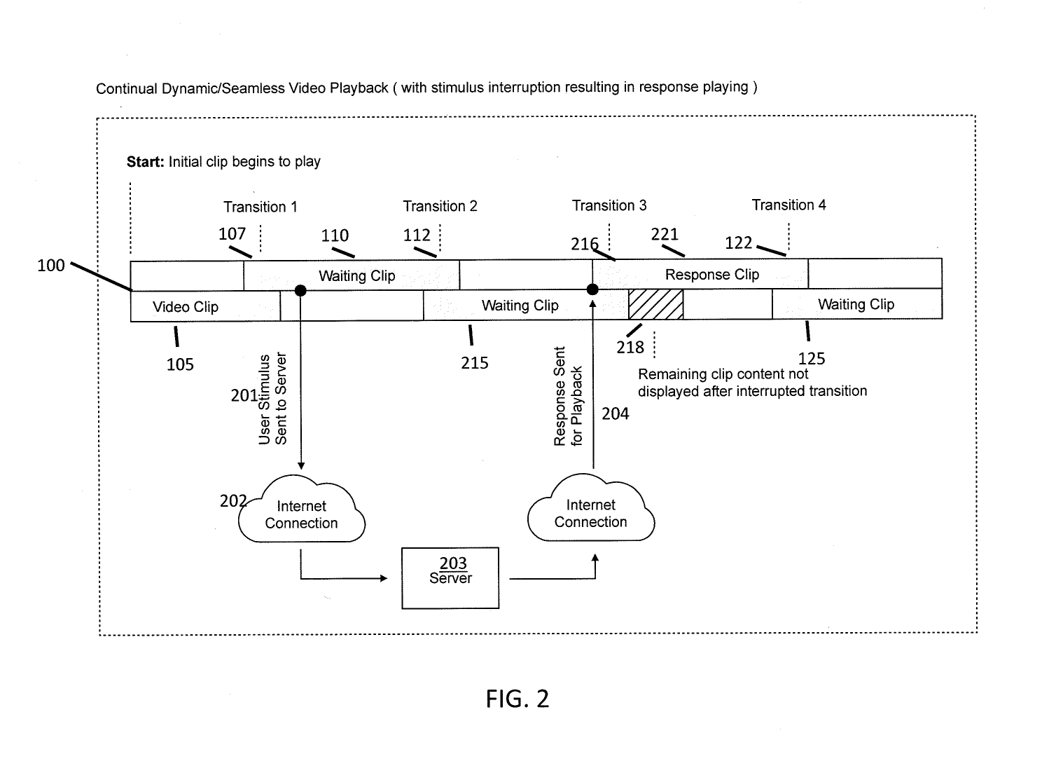

FIG. 2 is a schematic of a timeline of content displayed by an exemplary interactive video response platform when a stimulus is provided. As in FIG. 1, the first clip 105, which can be a welcome clip, starts 100 in response to an initial stimulus, such as an audience member clicking on the profile of a person of interest. The second video clip 110, which is a waiting clip, begins playing as the first video clip 105 ends, and the clips transition in a cross-fade dissolve in the first transition 107. During the playback of the second video clip 110, an audience member sends a stimulus (e.g. a question) 201 to a server 203 associated with the interactive video response platform via the Internet 202. The server 203 processes the stimulus and retrieves suitable response content, that is to say video clips or menu items, and sends a response 204 to be displayed via the Internet 202. While the stimulus 201 is being sent and processed, the rest of the second clip 110, a second transition 112, and a third video clip 215 are displayed by the interactive video response platform. It is possible that the response 204 interrupts the third video clip 215. During such an interruption, a third transition 216 that can include a cross-fade dissolve occurs and leads into the playback of a response clip 221 that corresponds to the response 204. The third video clip 215 can be a waiting clip, and the remainder of the third video clip 218 can be removed from any display queues or buffers used by the interactive video response platform in association with this interaction session, such as by deleting the data containing the remainder of the third video clip 218 from a memory, marking such data for deletion, or marking that data as not to be displayed, and the like. After the response clip 221 is displayed, a fourth transition 122 can occur before a fifth video clip 125 is displayed. The audience member can submit subsequent stimuli and the interactive video response platform can provide further responses, with waiting clips filling in any gaps in video clip playback, as needed.

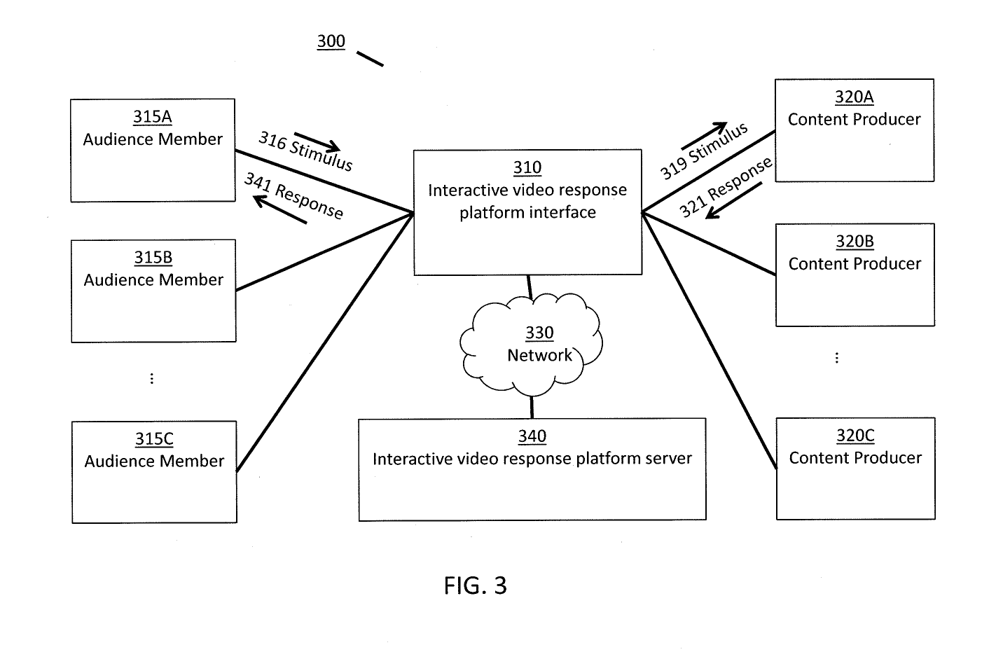

FIG. 3 is a diagram showing an example of a system 300 in which interaction between an interactive video response platform and one or more users takes place. The system 300 includes an interactive video response platform interface 310; one or more audience members 315A, 315B, 315C; stimulus sent by the audience 316; a network 330; an interactive video response platform server 340; a response 341 received by the audience member 315A; one or more content producers 320A, 320B, 320C; a stimulus 319 received by the content producer 320A; and a response 321 submitted by a content producer 320A. In the system 300, the audience members 315A, 315B, 315C can send stimulus 316 and receive responses 341 via the interactive video response platform interface 310. The interactive video response platform interface 310 can be a website, a proprietary application, a dedicated electronic device, or the like. A website or proprietary application can be displayed and interacted with via any suitable computing device including a desk top computer, a laptop computer, a tablet device, a smart phone, an electronic entertainment device, a gaming platform, a television, and the like. The stimulus 316 sent by the audience member 315A to interactive video response platform via the platform interface 310 can be sent to the interactive video response platform server 340 via the network 330. The network 330 can be any suitable network, such as the Internet, a local area network (LAN), a cellular network, and the like. The interactive video response platform server 340 is shown in a separate location from the interface 310 in FIG. 3. The platform server 340 can be on any suitable computer or computing device, in some instances on the same computing device as the platform interface 310. The one or more search algorithms associated with the interactive video response platform can compare a stimulus submitted by an audience member as a string and perform a series of checks. Such search algorithms can be located on the platform server 340.

The content producer 320A in FIG. 3 can send stimulus 319 and receive responses 321 via the interactive video response platform interface 310. For the content producers 320A, 320B, 320c, the interactive video response platform interface 310 can be a website, a proprietary application, a dedicated electronic device, a video studio/production facility associated with the interactive video response platform, or the like. The interactive video response platform interface 310 can display content, particularly response 341 content to the audience 315A, 315B, 315C as shown in FIGS. 1 and 2 in a seamless and persistent manner.

As described above, video clips are displayed seamlessly in response to questions posed by the audience member via the interactive video response platform. If the audience member is asking questions of a particular person of interest, the welcome clip produced by the person of interest may be the first video clip seen by the audience member. The welcome clip can prompt the audience member to ask questions, and if a question is not submitted to the interactive video response platform and ready to display before the welcome clip finishes, a waiting clip can be displayed by the interactive video response platform. A cross-fade dissolve transition creates an experience that is seamless, in that there is no discontinuity in the play-back of videos, and if the person of interest has created more than one waiting video, more than one waiting videos may be displayed to the audience member while the interactive video response platform awaits a question or other stimulus from the audience member.

At times, an answer, or response, to the stimulus (e.g. question) posed by the audience member to the interactive video response platform may not be available. In such an instance, the interactive video response platform can present a video clip with content that has been identified as a possible match, a menu with video clips that may be of interest to the audience member, or both. The audience member may provide further stimulus in the form of a response indicating that the proposed video clip can proceed to be played, selecting a menu item, or the like.

Stimulus can be provided by the audience member to the interactive video response platform through a website, an application specific to the interactive video response platform, or both. The stimulus can be typed by the audience member into a question-asking field, into a search field, or into a non-specific input field. Stimulus can also include clicks by the audience member to spell words, to browse through fields of interest (e.g. channels), or to select a field of interest or a person of interest in order to view questions previously answered. The audience member can also speak to provide his or her stimulus (such as via a microphone), and that spoken stimulus can be converted to text that can in turn be submitted to a general search field, a question-asking field, or a search field.

If a suitable response to the stimulus posed by the audience member cannot be located by the interactive video response platform, a “no-match” clip can be displayed and the stimulus (e.g. question) can be forwarded to the person of interest. When the person of interest responds to the stimulus submitted by the audience member, which may coincide with stimulus provided by multiple audience members, all of the audience members that have submitted similar stimulus to the same person of interest will receive a message or alert that their stimulus (e.g. question) has been responded to by that content producer. At that time, or any future time, the audience member may view the response through the interactive video response platform.

The interactive video response platform can include a server that can contain one or more databases to organize and/or store video clips, content producer information, audience member information, profiles for users, and the like. A website, a proprietary application, one or more video production studios associated with the interactive video response platform can be a part of the interactive video response platform. The interactive video response platform can also include software and hardware that enables seamless, persistent playback of relevant content that includes video clips, such that there is no discernible end to the playback of video clips in response to an audience member's stimulus or while waiting for further stimulus.

One or more search algorithms can also be a part of the interactive video response platform. The one or more search algorithms associated with the interactive video response platform can compare a stimulus submitted by an audience member as a string and perform a series of checks. One of the checks can be for the presence of inappropriate substrings (e.g. contains substrings that are on a predetermined list of inappropriate terms). In response to an inappropriate string, or stimulus, the interactive video response platform can return an “inappropriate content” video clip, if one exists for the content producer to whom the stimulus was posed. Another check that can be performed by one or more search algorithms associated with the interactive video response platform can be to compare the stimulus, as a string, to existing responses from the publisher and to then return a list if responses ranked by how closely the stimulus strings and responses match. If the highest ranked response to the stimulus meets a minimum required rank, then the server returns that response along with the response's associated media and metadata.

The interactive video response platform can be used by an audience member to pose a question to many content producers. The interactive video response platform can simulate a single, or a series of, initial in person interviews. For example, an audience member can be an employer who would like to screen potential employees based upon their answer to a question, such as “How many years of experience do you have in the field?” or “What was one of the biggest challenges at your last job?” Once the employer has found one or more potential employees with suitable answers, the employer can pose more questions to those selected potential employees, perhaps narrowing down the field while doing so. Eventually, the employer can decide that there are only three or fewer potential employees that he or she would like to meet in person to fill the opening, and then ask those few potential employees to face-to-face, real-time interviews, and eventually hire one or more of them.

In another example, the interactive video response platform can be used by a person searching for potential mates or persons to date. The interactive video response platform can simulate a single, or a series of, first dates, such that the person searching for potential mates can ask a series of questions that might be asked on a first date prior to an actual meeting. Such an audience member might wish to view all of the persons identifying themselves as interested in dating and who have answered questions such as “What is one of your favorite hobbies?” or “What do you like to eat?” In implementations where an audience member poses a question to multiple content producers, the audience member can choose to view further video clips or pose further questions to a specific content producer who answered his or her first question. Further, in the dating scenario, an audience member can search for all of the persons identifying themselves as interested in dating of a suitable sex, orientation, and other demographics, within a certain location. From the video clips returned by the interactive video response platform, the audience member can further search for those in his or her potential date pool who have indicated interest in a specific topic and/or answered a question related to a specific type of hobby or interest. Then the audience member can view the profile or profiles of the members of his or her potential date pool with interest in the specific type of hobby or interest and further determine who he or she would like to meet in person. Eventually, the audience member can send a message to one or more persons he or she would like to meet, potentially resulting in an in-person date, a phone conversation, or other similar real-time interaction.

In some implementations, an audience member can pose a question and be directed to a channel relating to a subject of interest, where content and/or producers relating to the same subject are made available by the interactive video response platform. The audience member might also go directly to a particular channel and ask a question, or otherwise provide stimulus only within that channel. Concurrently with being provided with an answer video clip or potential answer video clips, the audience member can be directed, via a menu, to one or more channels identified as related to his or her question by the interactive video response platform.

As described, above, a proprietary application can be used to access and interact with the interactive video response platform. A proprietary application can be free to an audience member to obtain and install on one or more computing devices. In some implementations, the audience member may have to pay to obtain and install a proprietary application that is associated with the interactive video response platform. Such a proprietary application, or app, may further be associated particularly with a specific channel, a category of channels, or a particular content producer (e.g. person of interest). Generation of a proprietary application may require payment by a content producer, if the proprietary application is specific to him or her. When paying to obtain and install a proprietary application, a periodic subscription fee can be assessed by the interactive video response platform, such as a monthly, a quarterly, a bi-annual, or a yearly fee.

Some video clips may be deemed premium content by the interactive video response platform. Premium content can include older content, longer video clips, content which is specific to an individual audience member or a smaller sub-set of audience members (e.g. special interest group or demographic), or content which the content producer feels warrants a fee. Fees may be charged by the interactive video response platform to post or to view premium content. For example, if a content producer is a subject expert, and has received the same question from approximately 1% of his or her audience, the content producer can choose to create a response to that question, but at a price. The price, or fee, can help offset the cost of generating the content or can be used to deter further requests of that nature.

Profiles can be associated with the interactive video response platform, both for audience members and content producers. Subscription or membership fees can be assessed for establishing a profile. Alternatively, it can be free to establish a profile, and free content can be created and/or viewed using such a profile, but premium content can cost extra. In some implementations, periodic membership fees can be assessed by the interactive video response platform. Profiles can include information regarding an audience member's or content producer's interests, demographics, location, and the like. Such information can help the interactive video response platform to provide relevant content or content options to an audience member, as well as to help a content provider select how to categorize his or her content when he or she wishes to associate it with a channel, keywords, and the like. An interface for the interactive video response platform can allow for interaction with a user's profile via a computing device, such as a computer, a tablet computing device, a smartphone, an entertainment device, a gaming platform, a dedicated electronic device, and the like.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving stimulus from a first user on an interactive video response platform;
receiving a first video content from a second user on the interactive video response platform, the first video content comprising a response to the stimulus;
displaying the first video content in response to the stimulus on the interactive video response platform; and
displaying a second video content on the interactive video response platform, in which the second video content is displayed as the first video content ends, creating a seamless video playback experience.

2. The method of claim 1, further comprising displaying a third video content on the interactive video response platform before the second video content ends.

3. The method of claim 1, wherein the second video content is a waiting video, displayed in response to a lack of stimulus from the first user.

4. The method of claim 1, wherein the seamless video playback experience comprises a cross-fade dissolve transition between the first video content and the second video content.

5. The method of claim 1, further comprising displaying a welcome video clip to the first user prior to displaying the first video content.

6. The method of claim 5, wherein the welcome video comprises a prompt to provide a stimulus comprising a question.

7. The method of claim 1, wherein the interactive video response platform is accessed by the first user through a web site, a proprietary application, or both a web site and a proprietary application.

8. The method of claim 1, wherein the second user creates the first video content through a web site, a proprietary application, or a video production studio.

9. A system comprising:
at least one programmable processor; and
a machine-readable medium storing instructions that, when executed by the at least one processor, cause the at least one programmable processor to perform operations comprising:
receiving a stimulus from a first user via an interactive video response platform;
receiving a first video content from a second user on the interactive video response platform, the first video content comprising a response to the stimulus;
displaying the first video content in response to the stimulus on the interactive video response platform; and
displaying a second video content on the interactive video response platform, in which the second video content is displayed as the first video content ends, creating a seamless video playback experience.

10. The system of claim 9, wherein the machine-readable medium further comprises instructions that cause the at least one programmable processor to further perform the operation of displaying a third video content on the interactive video response platform before the second video content ends.

11. The method of claim 9, wherein the second video content is a waiting video, displayed in response to a lack of stimulus from the first user.

12. The method of claim 9, wherein the seamless video playback experience comprises a cross-fade dissolve transition between the first video content and the second video content.

13. The method of claim 9, wherein the machine-readable medium further comprises instructions that cause the at least one programmable processor to further perform the operation of further comprising displaying a welcome video clip to the first user prior to displaying the first video content.

14. The method of claim 13, wherein the welcome video comprises a prompt to provide a stimulus comprising a question.

15. The method of claim 9, wherein the second user creates the first video content through a web site, a proprietary application, or a video production studio.

16. The method of claim 9, wherein the second user creates the first video content through a web site, a proprietary application, or a video production studio.

17. A computer program product comprising a machine-readable medium storing instructions that, when executed by at least one programmable processor, cause the at least one programmable processor to perform operations comprising:
receiving a stimulus from a first user on an interactive video response platform;
receiving a first video content from a second user on the interactive video response platform, the first video content comprising a response to the stimulus;
displaying the first video content in response to the stimulus on the interactive video response platform; and
displaying a second video content on the interactive video response platform, in which the second video content is displayed as the first video content ends, creating a seamless video playback experience.

18. The computer program product of claim 17, wherein the machine-readable medium further comprises instructions that cause the at least one programmable processor to further perform the operation of displaying a third video content on the interactive video response platform before the second video content ends.

19. The computer program product of claim 18, wherein the second video content is a waiting video, displayed in response to a lack of stimulus from the first user.

20. The computer program product of claim 17, wherein the seamless video playback experience comprises a cross-fade dissolve transition between the first video content and the second video content.
